(19) United States
(12) Patent Application Publication
(10) Pub. No.: US 2017/0345387 A1
(43) Pub. Date: Nov. 30, 2017

(54) METHOD OF DRIVING DISPLAY PANEL AND DISPLAY APPARATUS FOR PERFORMING THE SAME

(71) Applicant: SAMSUNG DISPLAY CO., LTD., Yongin-si (KR)

(72) Inventors: Jung-Won KIM, Seoul (KR); Jinpil KIM, Suwon-si (KR); Jaesung BAE, Suwon-si (KR); Namjae LIM, Gwacheon-si (KR)

(21) Appl. No.: 15/606,323

(22) Filed: May 26, 2017

(30) Foreign Application Priority Data
May 27, 2016 (KR) 10-2016-0065901

(51) Int. Cl. G09G 3/36; G09G 3/20; G09G 3/34; G09G 3/3291

(52) U.S. Cl. CPC G09G 3/3696; G09G 3/3607; G09G 3/3291; G09G 3/3648; G09G 3/3611; G09G 3/2003; G09G 3/342; G09G 3/3413; G09G 2320/0276; G09G 2320/0673

(57) ABSTRACT

A method for driving a display panel includes non-sequentially outputting gate signals to a plurality of gate lines in a gate line group, outputting data voltages to a plurality of data lines, and displaying a grayscale value based on the gate signal and the data voltage.

### CROSS-REFERENCE TO RELATED APPLICATION

Korean Patent Application No. 10-2016-0065901, filed on May 27, 2016, and entitled, “Method of Driving Display Panel and Display Apparatus for Performing the Same,” is incorporated by reference herein in its entirety.

### BACKGROUND

### 1. Field

One or more embodiments described herein relate to a method for driving a display panel and a display apparatus for performing such a method.

### 2. Description of the Related Art

A display apparatus may include a display panel and a driver. The display panel includes gate lines, data lines and a plurality of subpixels. The driver may include a gate driver to provide gate signals to the gate lines and a data driver to provide data voltages to the data lines. When the gate signals are sequentially applied to the display panel, a vertical line defect may occur as the result of the pixel structure of the display panel.

### SUMMARY

In accordance with one or more embodiments, a method for driving a display panel includes non-sequentially outputting gate signals to a plurality of gate lines in a gate line group; outputting data voltages to a plurality of data lines; and displaying a grayscale value based on the gate signal and the data voltage. The display panel may include a first subpixel connected to a first gate line and a first data line and a second subpixel adjacent to the first subpixel in a first direction and connected to a second gate line and the first data line. The first and second subpixels may emit same color light.

The display panel may include a third subpixel connected to a third gate line and the first data line and a fourth subpixel adjacent to the third subpixel in the first direction and connected to a fourth gate line and the first data line. The first subpixel and the second subpixel may be in a first side with respect to the first data line, and the third subpixel and the fourth subpixel may be in a second side opposite to the first side with respect to the first data line. The third subpixel and the fourth subpixel may emit same color light, and the third subpixel and the first subpixel may emit different color light. The display panel may include a fifth subpixel adjacent to the first subpixel in a second direction and connected to the third gate line and a second data line; and a sixth subpixel adjacent to the fifth subpixel in the first direction, and connected to the fourth gate line and the second data line. The third subpixel, the fourth subpixel, the fifth subpixel, and the sixth subpixel may emit same color light.

Data voltages having a first polarity may be applied to the first subpixel and the second subpixel in a first frame, data voltages having a second polarity opposite to the first polarity may be applied to the fifth subpixel and the sixth subpixel in the first frame. Data voltages having the second polarity may be applied to the first subpixel and the second subpixel in a second frame, data voltages having the first polarity may be applied to the fifth subpixel and the sixth subpixel in the second frame.

The gate line group may include a first gate line, a second gate line, a third gate line, a fourth gate line, a fifth gate line, and a sixth gate line which are sequentially disposed, and the gate signals may be respectively and sequentially applied to the first gate line, the third gate line, the fifth gate line, the second gate line, the fourth gate line and the sixth gate line in the gate line group.

The gate line group may include a first gate line, a second gate line, a third gate line, and a fourth gate line which are sequentially disposed, and the gate signals are respectively and sequentially may be applied to the first gate line, the third gate line, the second gate line, and the fourth gate line in the gate line group.

The gate line group may include a first gate line, a second gate line, a third gate line and a fourth gate line which are sequentially disposed, and the gate signals may be respectively and sequentially applied to the first gate line, the second gate line, the fourth gate line, and the third gate line in the gate line group.

In accordance with one or more other embodiments, a display apparatus includes a display panel including a plurality of gate line groups, the gate line group including a plurality of gate lines, a plurality of data lines and a plurality of subpixels connected to the gate lines and the data lines, the subpixel to display a grayscale value; a gate driver to non-sequentially output gate signals to the gate lines in the gate line group; and a data driver to output data voltages to the data lines.

The display panel may include a first subpixel connected to a first gate line and a first data line and a second subpixel adjacent to the first subpixel in a first direction and connected to a second gate line and the first data line.

The display panel may include a third subpixel connected to a third gate line and the first data line; and a fourth subpixel adjacent to the third subpixel in the first direction and connected to a fourth gate line and the first data line.

The display panel may include a fifth subpixel adjacent to the first subpixel in a second direction and connected to the third gate line and a second data line and a sixth subpixel adjacent to the fifth subpixel in the first direction and connected to the fourth gate line and the second data line.

The gate line group may include a first gate line, a second gate line, a third gate line, a fourth gate line, a fifth gate line, and a sixth gate line which are sequentially disposed, and the gate signals may be respectively and sequentially applied to the first gate line, the third gate line, the fifth gate line, the second gate line, the fourth gate line, and the sixth gate line in the gate line group.

The gate line group may include a first gate line, a second gate line, a third gate line, and a fourth gate line which are sequentially disposed, and the gate signals may be respectively and sequentially applied to the first gate line, the third gate line, the second gate line, and the fourth gate line in the gate line group.

The gate line group may include a first gate line, a second gate line, a third gate line, and a fourth gate line which are sequentially disposed, and the gate signals may be respectively and sequentially applied to the first gate line, the second gate line, the fourth gate line, and the third gate line in the gate line group.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display apparatus;

FIG. 2 illustrates an embodiment of a pixel structure;

FIG. 3A illustrates an example of polarities of data voltages that may be applied to the display panel of FIG. 1 in a first frame, and FIG. 3B illustrates an example of polarities of the data voltages applied to the display panel of FIG. 1 in a second frame;

FIG. 4 illustrates an example of gate signals and data voltages for a display panel;

FIG. 5 illustrates an embodiment of gate signals and data voltages for a display panel;

FIG. 6 illustrates another embodiment of gate signals and data voltages for a display panel; and

FIG. 7 illustrates another embodiment of gate signals and data voltages for a display panel.

### DETAILED DESCRIPTION

Example embodiments will be described with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments (or portions thereof) may be combined to form additional embodiments.

In the drawings, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

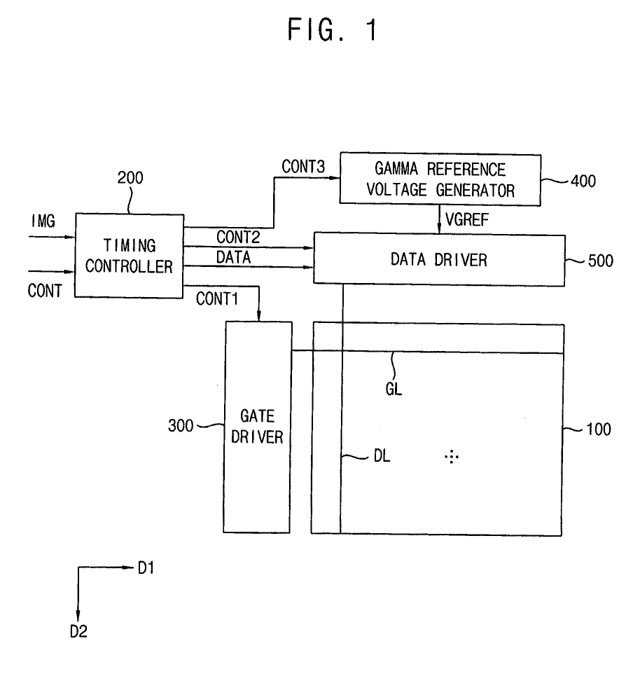

FIG. 1 illustrates an embodiment of a display apparatus which includes a display panel 100 and a display panel driver. The display panel driver includes a timing controller 200, a gate driver 300, a gamma reference voltage generator 400, and a data driver 500. The display panel 100 includes gate lines GL, data lines DL and a plurality of subpixels electrically connected to the gate lines GL and data lines DL. The gate lines GL extend in a first direction D1, and the data lines DL extend in a second direction D2 crossing the first direction D1.

Each subpixel may include at least one switching element, a liquid crystal capacitor, and a storage capacitor. The liquid crystal capacitor and the storage capacitor may be electrically connected to the switching element. The subpixels may be arranged in matrix form.

The timing controller 200 receives input image data IMG and an input control signal CONT from an external apparatus. The input image data may include red image data, green image data, and blue image data. The input control signal CONT may include a master clock signal and a data enable signal. The input control signal CONT may further include a vertical synchronizing signal and a horizontal synchronizing signal.

The timing controller 200 generates a first control signal CONT1, a second control signal CONT2, a third control signal CONT3, and a data signal DATA based on the input image data IMG and the input control signal CONT. The timing controller 200 generates the first control signal CONT1 for controlling operation of the gate driver 300 based on the input control signal CONT. The first control signal CONT1 is output to the gate driver 300. The first control signal CONT1 may further include a vertical start signal and a gate clock signal.

The timing controller 200 generates the second control signal CONT2 for controlling operation of the data driver 500 based on the input control signal CONT. The second control signal CONT2 is output to the data driver 500. The second control signal CONT2 may include a horizontal start signal and a load signal.

The timing controller 200 generates the data signal DATA based on the input image data IMG. The timing controller 200 outputs the data signal DATA to the data driver 500.

The timing controller 200 generates the third control signal CONT3 for controlling operation of the gamma reference voltage generator 400 based on the input control signal CONT, and outputs the third control signal CONT3 to the gamma reference voltage generator 400.

The gate driver 300 generates gate signals driving the gate lines GL based on the first control signal CONT1 received from the timing controller 200. The gate driver 300 outputs the gate signals to the gate lines GL. For example, the gate driver 300 may non-sequentially output the gate signals to the gate lines GL.

The gamma reference voltage generator 400 generates a gamma reference voltage VGREF based on the third control signal CONT3 from the timing controller 200. The gamma reference voltage generator 400 provides the gamma reference voltage VGREF to the data driver 500. The gamma reference voltage VGREF has a value corresponding to a level of the data signal DATA. In an exemplary embodiment, the gamma reference voltage generator 400 may be disposed in the timing controller 200, or in the data driver 500.

The data driver 500 receives the second control signal CONT2 and the data signal DATA from the timing controller 200, and receives the gamma reference voltages VGREF from the gamma reference voltage generator 400. The data driver 500 converts the data signal DATA to analog data voltages based on the gamma reference voltages VGREF. The data driver 500 outputs the data voltages to the data lines DL.

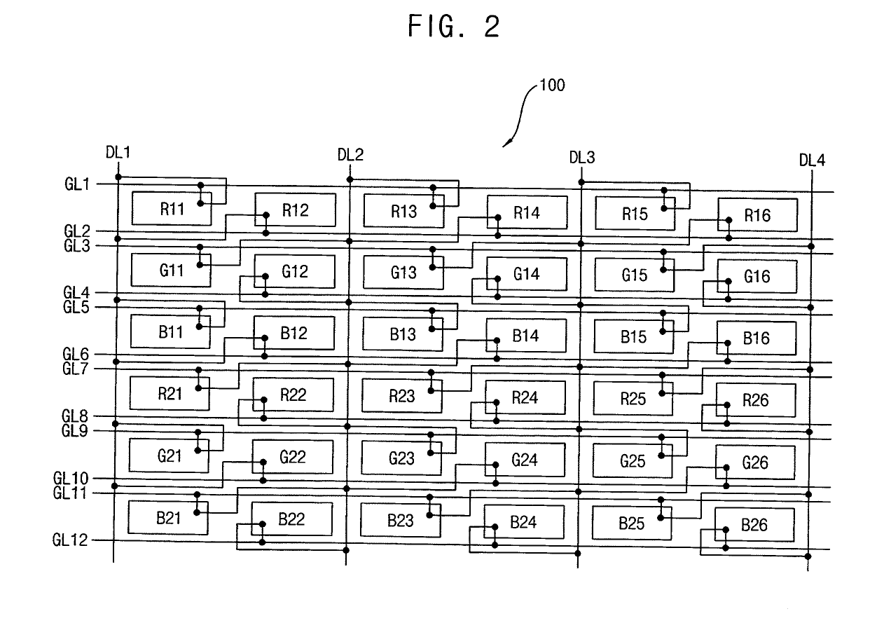

FIG. 2 illustrates an embodiment of a pixel structure of the display panel 100. Referring to FIGS. 1 and 2, a single subpixel row of the display panel 100 may be connected to two gate lines. For example, odd numbered subpixels in a first subpixel row may be connected to a gate line in an upper side of the first subpixel row, and even numbered subpixels in the first subpixel row may be connected to a gate line in a lower side of the first subpixel row.

Two subpixel columns of the display panel 100 may be alternately connected to two data lines. For example, odd numbered subpixels in first and second subpixel columns may be connected to a data line in a left side of the first and second subpixel columns, and even numbered subpixels in the first and second subpixel columns may be connected to a data line in a right side of the first and second subpixel columns.

Each subpixel row of the display panel 100 may include subpixels emitting light of a same color. Each subpixel column of the display panel 100 may include sequential arrangements of subpixels emitting light of three primary colors, e.g., such as but not limited to red, green and blue.

A first red subpixel R11 is connected to a first gate line GL1 and a first data line DL1. A second red subpixel R12 is adjacent to the first red subpixel R11 in the first direction D1. The second red subpixel R12 is connected to a second gate line GL2 and the first data line DL1. In one embodiment, no data line may be between the first red subpixel R11 and the second red subpixel R12.

A third red subpixel R13 is adjacent to the second red subpixel R12 in the first direction D1. The third red subpixel R13 is connected to the first gate line GL1 and a second data line DL2. A fourth red subpixel R14 is adjacent to the third red subpixel R13 in the first direction D1. The fourth red subpixel R14 is connected to the second gate line GL2 and the second data line DL2. In one embodiment, no data line may be between the third red subpixel R13 and the fourth red subpixel R14.

A fifth red subpixel R15 is adjacent to the fourth red subpixel R14 in the first direction D1. The fifth red subpixel R15 is connected to the first gate line GL1 and a third data line DL3. A sixth red subpixel R16 is adjacent to the fifth red subpixel R15 in the first direction D1. The sixth red subpixel R16 is connected to the second gate line GL2 and the third data line DL3. In one embodiment, no data line may be disposed between the fifth red subpixel R15 and the sixth red subpixel R16.

A first green subpixel G11 is adjacent to the first red subpixel R11 in a second direction D2. The first green subpixel G11 is connected to a third gate line GL3 and the second data line DL2. A second green subpixel G12 is adjacent to the first green subpixel G11 in the first direction D1. The second green subpixel G12 is adjacent to the second red subpixel R12 in the second direction D2. The second green subpixel G12 is connected to a fourth gate line GL4 and the second data line DL2. In one embodiment, no data line may be disposed between the first green subpixel G11 and the second green subpixel G12.

A third green subpixel G13 is adjacent to the second green subpixel G12 in the first direction D1. The third green subpixel G13 is adjacent to the third red subpixel R13 in the second direction D2. The third green subpixel G13 is connected to the third gate line GL3 and a third data line DL3. A fourth green subpixel G14 is adjacent to the third green subpixel G13 in the first direction D1. The fourth green subpixel G14 is adjacent to the fourth red subpixel R14 in the second direction D2. The fourth green subpixel G14 is connected to the fourth gate line GL4 and the third data line DL3. In one embodiment, no data line may be disposed between the third green subpixel G13 and the fourth green subpixel G14.

A fifth green subpixel G15 is adjacent to the fourth green subpixel G14 in the first direction D1. The fifth green subpixel G15 is adjacent to the fifth red subpixel R15 in the second direction D2. The fifth green subpixel G15 is connected to the third gate line GL3 and a fourth data line DL4. A sixth green subpixel G16 is adjacent to the fifth green subpixel G15 in the first direction D1. The sixth green subpixel G16 is adjacent to the sixth red subpixel R16 in the second direction D2. The sixth green subpixel G16 is connected to the fourth gate line GL4 and the fourth data line DL4. In one embodiment, no data line may be between the fifth green subpixel G15 and sixth green subpixel G16.

A first blue subpixel B11 is adjacent to the first green subpixel G11 in a second direction D2. The first blue subpixel B11 is connected to a fifth gate line GL5 and the first data line DL1. A second blue subpixel B12 is adjacent to the first blue subpixel B11 in the first direction D1. The second blue subpixel B12 is adjacent to the second green subpixel G12 in the second direction D2. The second blue subpixel B12 is connected to a sixth gate line GL6 and the first data line DL1. In one embodiment, no data line may be disposed between the first blue subpixel B11 and the second blue subpixel B12.

A third blue subpixel B13 is adjacent to the second blue subpixel B12 in the first direction D1. The third blue subpixel B13 is adjacent to the third green subpixel G13 in the second direction D2. The third blue subpixel B13 is connected to the fifth gate line GL5 and the second data line DL2. A fourth blue subpixel B14 is adjacent to the third blue subpixel B13 in the first direction D1. The fourth blue subpixel B14 is adjacent to the fourth green subpixel G14 in the second direction D2. The fourth blue subpixel B14 is connected to the sixth gate line GL6 and the second data line D12. In one embodiment, no data line may be disposed between the third blue subpixel B13 and the fourth blue subpixel B14.

A fifth blue subpixel B15 is adjacent to the fourth blue subpixel B14 in the first direction D1. The fifth blue subpixel B15 is adjacent to the fifth green subpixel G15 in the second direction D2. The fifth blue subpixel B15 is connected to the fifth gate line GL5 and the third data line DL3. A sixth blue subpixel B16 is adjacent to the fifth blue subpixel B15 in the first direction D1. The sixth blue subpixel B16 is adjacent to the sixth green subpixel G16 in the second direction D2. The sixth blue subpixel B16 is connected to the sixth gate line GL6 and the third data line DL3. In one embodiment, no data line may be disposed between the fifth blue subpixel B15 and the sixth blue subpixel B16. In FIG. 2, the display panel 100 has in six rows and six columns. In another embodiment, the display panel 100 may have a different number of rows and/or columns.

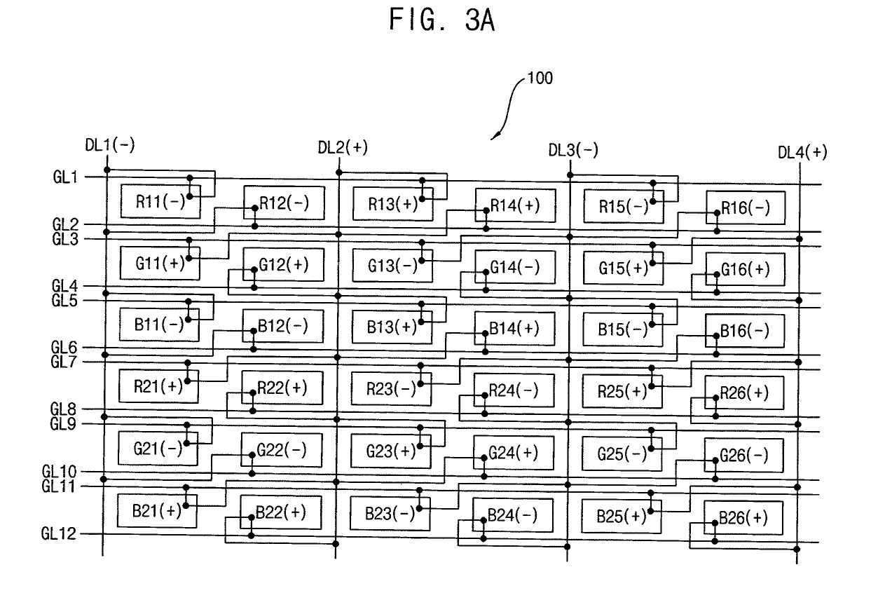

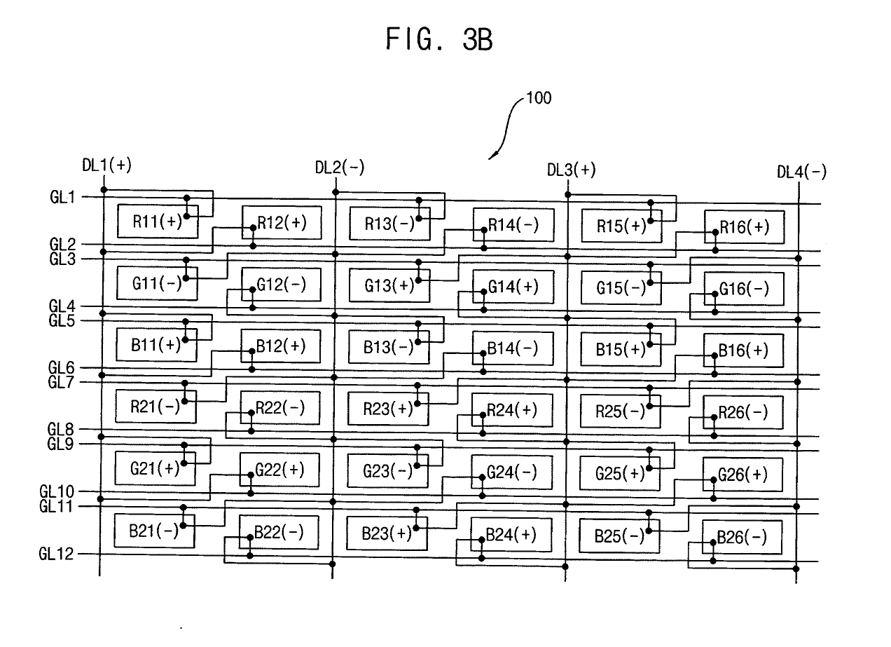

FIG. 3A illustrates an example of polarities of data voltages that may be applied to the display panel 100 in a first frame. FIG. 3B illustrates an example of polarities of data voltages applied to the display panel 100 in a second frame.

Referring to FIGS. 1 to 3B, data voltages having opposite polarities may be applied to adjacent data lines of the display panel 100. In FIG. 3A, data voltages having a positive polarity (+) are applied to the second data line DL2 and the fourth data line DL4. In FIG. 3A, data voltages having a negative polarity (−) are applied to the first data line DL1 and the third data line DL3. Therefore, the polarities of the data voltages may be inverted every two subpixels in a direction of the subpixel row. The polarities of the data voltages may be inverted every one subpixel in a direction of the subpixel column.

In FIG. 3A, the polarities of the data voltages applied to the subpixels R11, R12, R13, R14, R15 and R16 in the first subpixel row may be sequentially −, −, +, +, − and −. The polarities of the data voltages applied to the subpixels G11, G12, G13, G14, G15 and G16 in the second subpixel row may be sequentially +, +, −, −, + and +.

In FIG. 3A, the polarities of the data voltages applied to the subpixels R11, G11, B11, R21, G21 and B21 in the first subpixel column may be sequentially −, +, −, +, − and +. The polarities of the data voltages applied to the subpixels R12, G12, B12, R22, G22 and B22 in the second subpixel column may be sequentially −, +, −, +, − and +.

The polarities of the data voltages applied to the display panel 100 in the second frame may be opposite to the polarities of the data voltages applied to the display panel 100 in the first frame. In the second frame, the negative data voltages are applied to the pixels to which the positive data voltages were applied in the first frame. In the second frame, the positive data voltages are applied to the pixels to which the negative data voltages were applied in the first frame.

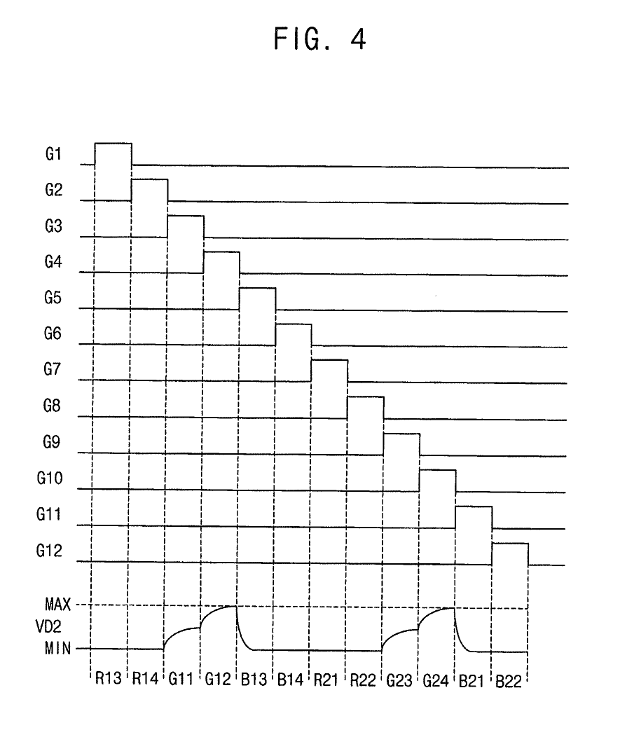

FIG. 4 illustrates an example of gate signals and data voltages when the gate signals are sequentially applied to the display panel 100 of FIG. 1. A single color image of green may be displayed on the display panel 100 in FIG. 4. Accordingly, the red subpixels and the blue subpixels may have a minimum grayscale value MIN, and the green subpixels may have the maximum grayscale MAX.

Referring to FIGS. 1 to 4, the gate signals G1 to G12 may be sequentially applied to the gate lines GL1 to GL12 of the display panel 100. A first gate signal G1 is applied to the first gate line GL1. A second gate signal G2 having a timing later than a timing of the first gate signal G1 is applied to the second gate line GL2. A third gate signal G3 having a timing later than the timing of the second gate signal G2 is applied to the third gate line GL3. A fourth gate signal G4 having a timing later than the timing of the third gate signal G3 is applied to the fourth gate line GL4. In FIG. 4, a second data voltage VD2 is applied to the second data line DL2 of FIG. 2, where the second data voltage VD2 has positive polarity.

When the gate signals are sequentially applied to the gate lines GL1 to GL12 and the display panel 100 displays single green color image, the target grayscale of the first green subpixel G11 is the maximum grayscale MAX and the target grayscale of the fourth red subpixel R14 (which is the previous subpixel of the first green subpixel G11) is the minimum grayscale MIN. Thus, the charging rate of the first green subpixel G11 may be relatively insufficient.

In contrast, the target grayscale of the second green subpixel G12 is the maximum grayscale MAX and the target grayscale of the first green subpixel G11 (which is the previous subpixel of the second green subpixel G12) is the maximum grayscale MAX. Thus, the charging rate of the second green subpixel G12 may be greater than the charging rate of the first green subpixel G11. Due to the difference of the charging rates between the first and second green subpixels G11 and G12, the second green subpixel G12 may emit green image light brighter than the green image light emitted by the first green subpixel G11.

The fourth green subpixel G14 may emit green image light brighter than the green image light emitted by the third green subpixel G13. The sixth green subpixel G16 may emit green image light brighter than the green image light emitted by the fifth green subpixel G15. The eighth green subpixel G22 may display green image light brighter than the green image light emitted by the seventh green subpixel G21. The tenth green subpixel G24 may emit green image light brighter than the green image light emitted by the ninth green subpixel G23. The twelfth green subpixel G26 may emit green image light brighter than the green image light emitted by the eleventh green subpixel G25.

As a result, when the gate signals are sequentially applied to the gate lines GL1 to GL12 and the display panel 100 displays a single green color image, the green subpixels in the even-numbered subpixel columns emit green image light brighter than the green image light of the green subpixels in the odd-numbered subpixel columns. Thus, a vertical line defect may be generated. The vertical line defect may be more serious in a lower portion of the display panel 100 due to a propagation delay of the data line DL.

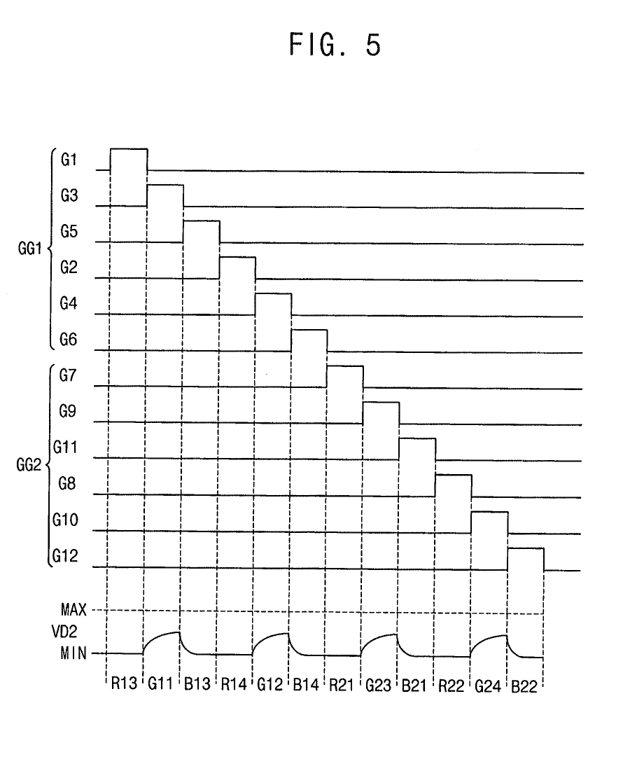

FIG. 5 illustrates an example of gate signals and data voltages when gate line groups of the display panel 100 of FIG. 1 respectively include six gate lines and the gate signals and are non-sequentially applied to the display panel of FIG. 1 in the gate line group. It is assumed that a single green color image is displayed on the display panel 100 in FIG. 5. Accordingly, the red subpixels and the blue subpixels may have the minimum grayscale MIN. The green subpixels may have the maximum grayscale MAX. In addition, in FIG. 5, a second data voltage VD2 is applied to the second data line DL2 of FIG. 2, where the second data voltage VD2 has positive polarity.

The gate lines of the display panel 100 are grouped in a plurality of gate line groups. In the present exemplary embodiment, the gate line group includes six gate lines. For example, a first gate line group GG1 includes a first gate line GL1, a second gate line GL2, a third gate line GL3, a fourth gate line GL4, a fifth gate line GL5, and a sixth gate line GL6 which are sequentially disposed. The gate signals G1, G3, G5, G2, G4 and G6 may be respectively and sequentially applied to the first gate line GL1, the third gate line GL3, the fifth gate line GL5, the second gate line GL2, the fourth gate line GL4 and the sixth gate line GL6 in the first gate line group GG1.

A second gate line group GG2 includes a first gate line GL7, a second gate line GL8, a third gate line GL9, a fourth gate line GL10, a fifth gate line GL11 and a sixth gate line GL12 which are sequentially disposed. The gate signals G7, G9, G11, G8, G10 and G12 may be respectively and sequentially applied to the first gate line GL7, the third gate line GL9, the fifth gate line GL11, the second gate line GL8, the fourth gate line GL10 and the sixth gate line GL12 in the second gate line group GG2.

When the gate signals are non-sequentially applied to the gate lines GL1 to GL6 as explained above (e.g. G1-G3-G5-G2-G4-G6) and the display panel 100 displays a single green color image, the target grayscale of the first green subpixel G11 is the maximum grayscale MAX and the target grayscale of the third red subpixel R13 (which is the previous subpixel of the first green subpixel G11) is the minimum grayscale MIN. Similarly, the target grayscale of the second green subpixel G12 is the maximum grayscale MAX and the target grayscale of the fourth red subpixel R14 (which is the previous subpixel of the second green subpixel G12) is the minimum grayscale MIN. Accordingly, the charging rate of the second green subpixel G12 may be substantially the same as the charging rate of the first green subpixel G11.

As a result, when the gate signals are non-sequentially applied to the gate lines GL1 to GL12 (e.g. G1-G3-G5-G2-G4-G6-G7-G9-G11-G8-G10-G12) and the display panel 100 displays a single green color image, the green subpixels in the even-numbered subpixel columns emit green image light having a luminance substantially the same as a luminance of the green image light emitted by the green subpixels in the odd-numbered subpixel columns. Thus, the vertical line defect may be prevented.

The display panel 100 has been described above as displaying a single green color image. In another embodiment, the display panel 100 may display a single red color image, single blue color image, a mixed color image (magenta) of red and blue, a mixed color image (yellow) of red and green, or a mixed color image (cyan) of green and blue in a similar manner, to prevent a vertical line defect.

The gate line group described above includes the six gate lines. In one embodiment, the gate line group may include 6x gate lines, where x is a natural number. For example, the gate line group may include twelve gate lines, eighteen gate lines, or another number of gate lines.

According to one or more embodiments, the gate lines of the display panel 100 are grouped and the gate signals are non-sequentially applied to the gate lines in the gate line group. Thus, the vertical line defect may be prevented when the display panel 100 displays a single color image or a mixed color image of two primary colors. Therefore, the display quality of the display panel 100 may be improved.

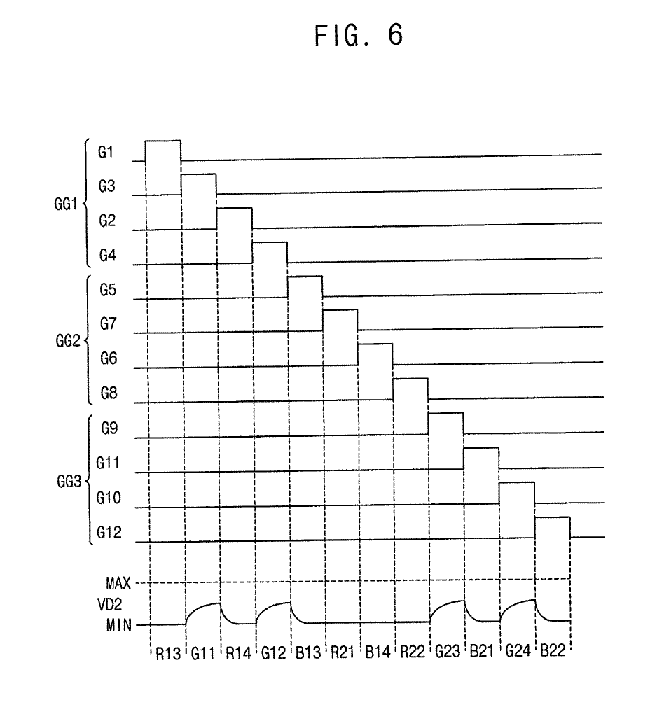

FIG. 6 illustrates another embodiment of gate signals and data voltages when gate line groups of a display panel 100 includes four gate lines and the gate signals and are non-sequentially applied to the display panel of FIG. 1 in the gate line group.

The method of driving the display panel and the display apparatus according to the present exemplary embodiment may be substantially the same as the method of driving the display panel and the display apparatus of the previous exemplary embodiment explained with reference to FIGS. 1 to 5, except for the method of grouping the gate lines and the sequence of applying the gate signals to the gate lines.

A single green color image is displayed on the display panel 100 in FIG. 6. Thus, the red subpixels and the blue subpixels may have the minimum grayscale MIN. The green subpixels may have the maximum grayscale MAX. In addition, in FIG. 6, a second data voltage VD2 is applied to the second data line DL2 of FIG. 2, where the second data voltage VD2 has positive polarity.

Referring to FIGS. 1, 2, 3A, 3B, and 6, the display apparatus includes a display panel 100 and a display panel driver. The display panel driver includes a timing controller 200, a gate driver 300, a gamma reference voltage generator 400 and a data driver 500. A single subpixel row of the display panel 100 may be connected to two gate lines. For example, odd numbered subpixels in a first subpixel row may be connected to a gate line in an upper side of the first subpixel row, and even numbered subpixels in the first subpixel row may be connected to a gate line disposed in a lower side of the first subpixel row.

Two subpixel columns of the display panel 100 may be alternately connected to two data lines. For example, odd numbered subpixels in first and second subpixel columns may be connected to a data line in a left side of the first and second subpixel columns, and even numbered subpixels in the first and second subpixel columns may be connected to a data line disposed in a right side of the first and second subpixel columns.

The subpixel row of the display panel 100 may include subpixels emitting same color light. The subpixel column of the display panel 100 may include sequential arrangements of subpixels emitting light of three primary colors, such as but not limited to red, green and blue.

The gate lines of the display panel 100 are grouped in a plurality of gate line groups. Each gate line group includes, for example, four gate lines. For example, a first gate line group GG1 includes a first gate line GL1, a second gate line GL2, a third gate line GL3 and a fourth gate line GL4 which are sequentially disposed. The gate signals G1, G3, G2 and G4 may be respectively and sequentially applied to the first gate line GL1, the third gate line GL3, the second gate line GL2 and the fourth gate line GL4 in the first gate line group GG1.

A second gate line group GG2 includes a first gate line GL5, a second gate line GL6, a third gate line GL7 and a fourth gate line GL8 which are sequentially disposed. The gate signals G5, G7, G6 and G8 may be respectively and sequentially applied to the first gate line GL5, the third gate line GL7, the second gate line GL6 and the fourth gate line GL8 in the second gate line group GG2.

A third gate line group GG3 includes a first gate line GL9, a second gate line GL10, a third gate line GL11 and a fourth gate line GL12 which are sequentially disposed. The gate signals G9, G11, G10 and G12 may be respectively and sequentially applied to the first gate line GL9, the third gate line GL11, the second gate line GL10 and the fourth gate line GL12 in the third gate line group GG3.

When the gate signals are non-sequentially applied to the gate lines GL1 to GL4 as explained above (e.g. G1-G3-G2-G4) and the display panel 100 displays single green color image, the target grayscale of the first green subpixel G11 is the maximum grayscale MAX and the target grayscale of the third red subpixel R13 (which is the previous subpixel of the first green subpixel G11) is the minimum grayscale MIN. Similarly, the target grayscale of the second green subpixel G12 is the maximum grayscale MAX and the target grayscale of the fourth red subpixel R14 (which is the previous subpixel of the second green subpixel G12) is the minimum grayscale MIN. Accordingly, the charging rate of the second green subpixel G12 may be substantially the same as the charging rate of the first green subpixel G11.

As a result, when the gate signals are non-sequentially applied to the gate lines GL1 to GL12 (e.g. G1-G3-G2-G4-G5-G7-G6-G8-G9-G11-G10-G12) and the display panel 100 displays the single color image of green, the green subpixels in the even-numbered subpixel columns display the green images having a luminance substantially the same as a luminance of the green images of the green subpixels in the odd-numbered subpixel columns. Thus, the vertical line defect may be prevented.

The display panel 100 described above displays a single green color image. In another embodiment, the display panel 100 may display a single red color image, a single blue color image, a mixed color image (magenta) of red and blue, a mixed color image (yellow) of red and green, or a mixed color image (cyan) of green and blue in a similar manner to prevent a vertical line defect.

Although the gate line group including the four gate lines is illustrated in the present exemplary embodiment, the present inventive concept is not limited thereto. The gate line group may include 4x gate lines. Herein x is a natural number. For example, the gate line group may include eight gate lines. Alternatively, the gate line group may include twelve gate lines.

According to the present exemplary embodiment, the gate lines of the display panel 100 are grouped and the gate signals are non-sequentially applied to the gate lines in the gate line group. Thus, the vertical line defect may be prevented when the display panel 100 displays a single color image or a mixed color image of two primary colors. Therefore, the display quality of the display panel 100 may be improved.

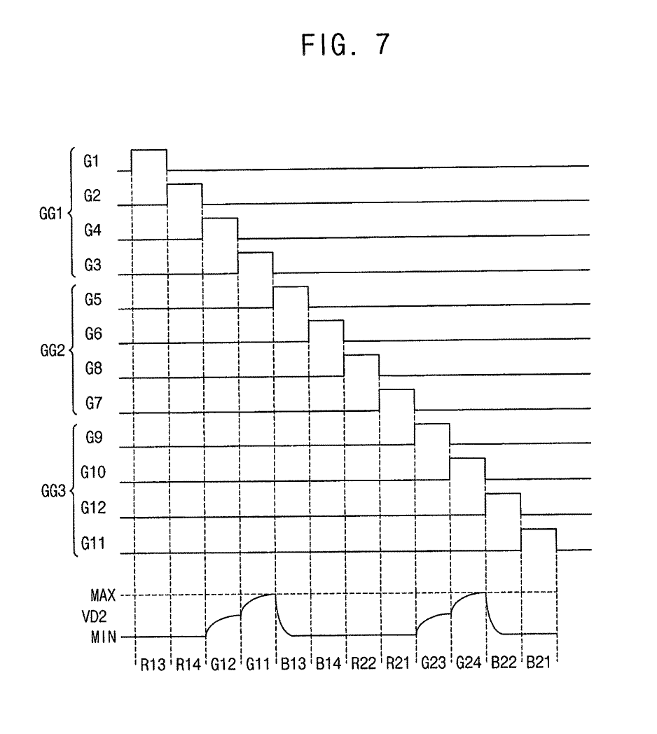

FIG. 7 illustrates another embodiment of gate signals and data voltages when gate line groups of a display panel 100 respectively include four gate lines and the gate signals and are non-sequentially applied to the display panel of FIG. 1 in the gate line group. The method of driving the display panel and the display apparatus according to the present exemplary embodiment may be substantially the same as the method of driving the display panel and the display apparatus of the previous exemplary embodiment explained with reference to FIGS. 1 to 5, except for the method of grouping the gate lines and the sequence of applying the gate signals to the gate lines.

A single green color image is displayed on the display panel 100 in FIG. 7. Accordingly, the red subpixels and the blue subpixels may have the minimum grayscale MIN, and the green subpixels may have the maximum grayscale MAX. In addition, in FIG. 7, a second data voltage VD2 is applied to the second data line DL2 of FIG. 2, where the second data voltage VD2 has positive polarity.

Referring to FIGS. 1, 2, 3A, 3B and 7, the display apparatus includes a display panel 100 and a display panel driver. The display panel driver includes a timing controller 200, a gate driver 300, a gamma reference voltage generator 400 and a data driver 500. A single subpixel row of the display panel 100 may be connected to two gate lines. For example, odd numbered subpixels in a first subpixel row may be connected to a gate line in an upper side of the first subpixel row. For example, even numbered subpixels in the first subpixel row may be connected to a gate line in a lower side of the first subpixel row.

Two subpixel columns of the display panel 100 may be alternately connected to two data lines. For example, odd numbered subpixels in first and second subpixel columns may be connected to a data line in a left side of the first and second subpixel columns. For example, even numbered subpixels in the first and second subpixel columns may be connected to a data line in a right side of the first and second subpixel columns.

The subpixel row of the display panel 100 may include subpixels emitting same color light. The subpixel column of the display panel 100 may include a sequential arrangements of subpixels emitting light of three primary colors, such as but not limited to red, green and blue.

The gate lines of the display panel 100 are grouped in a plurality of gate line groups, e.g., each gate line group including four gate lines. For example, a first gate line group GG1 includes a first gate line GL1, a second gate line GL2, a third gate line GL3 and a fourth gate line GL4 which are sequentially disposed. The gate signals G1, G2, G4 and G3 may be respectively and sequentially applied to the first gate line GL1, the second gate line GL2, the fourth gate line GL4 and the third gate line GL3 in the first gate line group GG1.

A second gate line group GG2 includes a first gate line GL5, a second gate line GL6, a third gate line GL7 and a fourth gate line GL8 which are sequentially disposed. The gate signals G5, G6, G8 and G7 may be respectively and sequentially applied to the first gate line GL5, the second gate line GL6, the fourth gate line GL8 and the third gate line GL7 in the second gate line group GG2.

A third gate line group GG3 includes a first gate line GL9, a second gate line GL10, a third gate line GL11 and a fourth gate line GL12 which are sequentially disposed. The gate signals G9, G10, G12 and G11 may be respectively and sequentially applied to the first gate line GL9, the second gate line GL10, the fourth gate line GL12 and the third gate line GL11 in the third gate line group GG3.

When the gate signals are non-sequentially applied to the gate lines GL1 to GL4 as explained above (e.g. G1-G2-G4-G3) and the display panel 100 displays a single green color image, the target grayscale of the second green subpixel G12 is the maximum grayscale MAX and the target grayscale of the fourth red subpixel R14 (which is the previous subpixel of the second green subpixel G12) is the minimum grayscale MIN. Thus, the charging rate of the second green subpixel G12 may be relatively insufficient.

In contrast, the target grayscale of the first green subpixel G11 is the maximum grayscale MAX and the target grayscale of the second green subpixel G12 (which is the previous subpixel of the first green subpixel G11) is the maximum grayscale MAX. Thus, the charging rate of the first green subpixel G11 may be greater than the charging rate of the second green subpixel G12. Due to the difference of the charging rates between the first and second green subpixels G11 and G12, the first green subpixel G11 may emit green image light brighter than the green image light emitted by of the second green subpixel G12.

Referring to the fifth subpixel row of FIG. 2, the target grayscale of the ninth green subpixel G23 is the maximum grayscale MAX and the target grayscale of the seventh red subpixel R21 (which is the previous subpixel of the ninth green subpixel G23) is the minimum grayscale MIN. Thus, the charging rate of the ninth green subpixel G23 may be relatively insufficient. In contrast, the target grayscale of the tenth green subpixel G24 is the maximum grayscale MAX and the target grayscale of the ninth green subpixel G23 (which is the previous subpixel of the tenth green subpixel G24) is the maximum grayscale MAX. Thus, the charging rate of the tenth green subpixel G24 may be greater than the charging rate of the ninth green subpixel G23. Due to the difference of the charging rates between the ninth and tenth green subpixels G23 and G214, the tenth green subpixel G24 may emit green image light brighter than green image light emitted by the ninth green subpixel G23.

Similarly, in the second subpixel row, the green subpixels in the odd-numbered subpixel columns emit green image light brighter than the green image light emitted by the green subpixels in the even-numbered subpixel columns. In contrast, similarly, in the fifth subpixel row, the green subpixels in the even-numbered subpixel columns emit green image light brighter than the green image light emitted by the green subpixels in the odd-numbered subpixel columns.

As a result, when the gate signals are non-sequentially applied to the gate lines GL1 to GL12 (e.g. G1-G2-G4-G3-G5-G6-G8-G7-G9-G10-G12-G11) and the display panel 100 displays a single green color image, the green subpixels in the odd-numbered subpixel columns emit green image light brighter than the green image light emitted by the green subpixels in the even-numbered subpixel columns in some subpixel rows (e.g. (6x+2)-subpixel rows). However, the green subpixels in the even-numbered subpixel columns emit green image light brighter than the green image light emitted by the green subpixels in the odd-numbered subpixel columns in other subpixel rows (e.g. (6x+5)-subpixel rows). Thus, the vertical line defect may not be explicitly shown to a user.

The display panel 100 described above displays a single green color image. In another embodiment, the display panel 100 may display a single red color image, a single blue color image, a mixed color image (magenta) of red and blue, a mixed color image (yellow) of red and green, or a mixed color image (cyan) of green and blue in a similar manner to prevent a vertical line defect.

Each gate line group described above includes the four gate lines. In another embodiment, each gate line group include 4x gate lines, where x is a natural number, e.g., eight gate lines, twelve gate lines, or another number of gate lines.

According to the present exemplary embodiment, the gate lines of the display panel 100 are grouped and the gate signals are non-sequentially applied to the gate lines in the gate line group. Thus, the vertical line defect may not be visible to a user when the display panel 100 displays a single color image or the mixed color image of two primary colors. Therefore, the display quality of the display panel 100 may be improved.

In accordance with one or more of the aforementioned embodiments, a method for driving a display panel and a display apparatus implementing the method non-sequentially applies a gate signal to a portion of the display panel to prevent a vertical line defect. Thus, display quality of the display panel may be improved.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the embodiments set forth in the following claims.

What is claimed is:

1. A method for driving a display panel, the method comprising:
non-sequentially outputting gate signals to a plurality of gate lines in a gate line group;
outputting data voltages to a plurality of data lines; and
displaying a grayscale value based on the gate signal and the data voltage.

2. The method as claimed in claim 1, wherein the display panel includes:
a first subpixel connected to a first gate line and a first data line; and
a second subpixel adjacent to the first subpixel in a first direction and connected to a second gate line and the first data line.

3. The method as claimed in claim 2, wherein the first subpixel and the second subpixel emit same color light.

4. The method as claimed in claim 2, wherein the display panel includes:
a third subpixel connected to a third gate line and the first data line; and
a fourth subpixel adjacent to the third subpixel in the first direction and connected to a fourth gate line and the first data line.

5. The method as claimed in claim 4, wherein:
the first subpixel and the second subpixel are in a first side with respect to the first data line, and
the third subpixel and the fourth subpixel are in a second side opposite to the first side with respect to the first data line.

6. The method as claimed in claim 4, wherein:
the third subpixel and the fourth subpixel emit same color light, and
the third subpixel and the first subpixel emit different color light.

7. The method as claimed in claim 4, wherein the display panel includes:
a fifth subpixel adjacent to the first subpixel in a second direction and connected to the third gate line and a second data line; and
a sixth subpixel adjacent to the fifth subpixel in the first direction, and connected to the fourth gate line and the second data line.

8. The method as claimed in claim 7, wherein the third subpixel, the fourth subpixel, the fifth subpixel, and the sixth subpixel emit same color light.

9. The method as claimed in claim 7, wherein:
data voltages having a first polarity are applied to the first subpixel and the second subpixel in a first frame,
data voltages having a second polarity opposite to the first polarity are applied to the fifth subpixel and the sixth subpixel in the first frame.

10. The method as claimed in claim 9, wherein:
data voltages having the second polarity are applied to the first subpixel and the second subpixel in a second frame,
data voltages having the first polarity are applied to the fifth subpixel and the sixth subpixel in the second frame.

11. The method as claimed in claim 1, wherein:
the gate line group includes a first gate line, a second gate line, a third gate line, a fourth gate line, a fifth gate line, and a sixth gate line which are sequentially disposed, and
the gate signals are respectively and sequentially applied to the first gate line, the third gate line, the fifth gate line, the second gate line, the fourth gate line and the sixth gate line in the gate line group.

12. The method as claimed in claim 1, wherein:
the gate line group includes a first gate line, a second gate line, a third gate line, and a fourth gate line which are sequentially disposed, and
the gate signals are respectively and sequentially applied to the first gate line, the third gate line, the second gate line, and the fourth gate line in the gate line group.

13. The method as claimed in claim 1, wherein:
the gate line group includes a first gate line, a second gate line, a third gate line and a fourth gate line which are sequentially disposed, and
the gate signals are respectively and sequentially applied to the first gate line, the second gate line, the fourth gate line, and the third gate line in the gate line group.

14. A display apparatus, comprising:
a display panel including a plurality of gate line groups, the gate line group including a plurality of gate lines, a plurality of data lines and a plurality of subpixels connected to the gate lines and the data lines, the subpixel to display a grayscale value;
a gate driver to non-sequentially output gate signals to the gate lines in the gate line group; and
a data driver to output data voltages to the data lines.

15. The display apparatus as claimed in claim 14, wherein the display panel includes:
a first subpixel connected to a first gate line and a first data line; and
a second subpixel adjacent to the first subpixel in a first direction and connected to a second gate line and the first data line.

16. The display apparatus as claimed in claim 15, wherein the display panel includes:
a third subpixel connected to a third gate line and the first data line; and
a fourth subpixel adjacent to the third subpixel in the first direction and connected to a fourth gate line and the first data line.

17. The display apparatus as claimed in claim 16, wherein the display panel includes:
a fifth subpixel adjacent to the first subpixel in a second direction and connected to the third gate line and a second data line; and
a sixth subpixel adjacent to the fifth subpixel in the first direction and connected to the fourth gate line and the second data line.

18. The display apparatus as claimed in claim 14, wherein:
the gate line group includes a first gate line, a second gate line, a third gate line, a fourth gate line, a fifth gate line, and a sixth gate line which are sequentially disposed, and
the gate signals are respectively and sequentially applied to the first gate line, the third gate line, the fifth gate line, the second gate line, the fourth gate line, and the sixth gate line in the gate line group.

19. The display apparatus as claimed in claim 14, wherein:
the gate line group including a first gate line, a second gate line, a third gate line, and a fourth gate line which are sequentially disposed, and
the gate signals are respectively and sequentially applied to the first gate line, the third gate line, the second gate line, and the fourth gate line in the gate line group.

20. The display apparatus as claimed in claim 14, wherein:
the gate line group includes a first gate line, a second gate line, a third gate line, and a fourth gate line which are sequentially disposed, and
the gate signals are respectively and sequentially applied to the first gate line, the second gate line, the fourth gate line, and the third gate line in the gate line group.
